(19) United States
(12) Patent Application Publication
(10) Pub. No.: US 2016/0161284 A1
(43) Pub. Date: Jun. 9, 2016

(54) MICROFORCE MEASURING DEVICE

(71) Applicant: NATIONAL CHUNG SHAN INSTITUTE OF SCIENCE AND TECHNOLOGY, LONGTAN TOWNSHIP (TW)

(72) Inventors: RUH-HUA WU, LONGTAN TOWNSHIP (TW); TING-HUNG SU, ZAOQIAO TOWNSHIP (TW); CHUNG-TSENG CHANG, BADE CITY (TW)

(21) Appl. No.: 14/562,819

(22) Filed: Dec. 8, 2014

(51) Int. Cl. G01D 5/14; G01W 1/14; G01L 1/04

(52) U.S. Cl. CPC G01D 5/142; G01L 1/04; G01W 1/14

(57) ABSTRACT

A microforce measuring device includes a base; a fixing component disposed at the base; a cantilever fixed at one end by the fixing component; a magnetic component disposed at the cantilever; a Hall effect sensing unit disposed at the base, aimed at the magnetic component, and spaced apart from the magnetic component by a distance to sense a change in a magnetic field of the magnetic component and generate a sensing signal; and a signal processing unit electrically connected to the Hall effect sensing unit to receive and analyze the sensing signal. Parts and components of the microforce measuring device are commercially available and cheap, so that the microforce measuring device incurs low manufacturing costs and measures a variation in a force of less than 5 gf precisely.

### FIELD OF TECHNOLOGY

The present invention relates to measuring devices, and more particularly, to a microforce measuring device.

### BACKGROUND

A conventional ball screw applies to precise manufacturing and transmission mechanism. Calculation of the mechanical efficiency of the ball screw entails measuring a thrust of the ball screw first. The thrust, which is usually less than 5 gf or even 1 gf, is hereunder referred to as a microforce.

There are two types of conventional sensors for measuring a microforce, namely resistive sensors and application of strain gauges. Resistive sensors have a measurement range of 10 gf-1 kgf and therefore cannot measure any microforce of less than 5 gf. Regarding the application of strain gauges, a strain gauge and a circuit processor jointly measure the microforce; since the strain is usually small, it is not measurable by the aforesaid combination. As a result, the application of strain gauges necessitates an amplifier. However, when amplified with the amplifier, the measured data is susceptible to distortion and therefore is predisposed to errors. Moreover, since the circuit processor is expensive, the measurement of microforces with strain gauges incurs high costs. The strain gauges are exemplified by a strain gauge element of U.S. Pat. No. 5,199,519 and adapted to measure or detect a force.

Accordingly, it is important to provide a sensor of a microforce, which incurs low manufacturing costs and measures a variation in a force of less than 5 gf precisely.

Citation Document: U.S. Pat. No. 5,199,519

### SUMMARY

In view of the aforesaid drawbacks of the prior art, it is an objective of the present invention to provide a microforce measuring device which incurs low manufacturing costs and measures a variation in a force of less than 5 gf precisely.

Another objective of the present invention is to provide a microforce measuring device for use in detecting a change in a microforce, for example, detecting rain intensity, and detecting wind intensity.

In order to achieve the above and other objectives, the present invention provides a microforce measuring device, comprising: a base; a fixing component disposed at the base; a cantilever fixed at one end by the fixing component; a magnetic component disposed at the cantilever; a Hall effect sensing unit disposed at the base, aimed at the magnetic component, and spaced apart from the magnetic component by a distance to sense a change in a magnetic field of the magnetic component and generate a sensing signal; and a signal processing unit electrically connected to the Hall effect sensing unit to receive and analyze the sensing signal.

In the microforce measuring device, the Hall effect sensing unit and the magnetic component are spaced apart by a distance of 5 mm.

In the microforce measuring device, the Hall effect sensing unit is aimed at a junction of two poles of the magnetic component.

In the microforce measuring device, the magnetic component is an axially-magnetized two-pole magnetic block.

In the microforce measuring device, the Hall effect sensing unit is a linear Hall transducer.

In the microforce measuring device, the cantilever is made of a magnetically impermeable material.

In conclusion, the microforce measuring device of the present invention comprises the aforesaid parts and components to thereby reduce manufacturing costs and measure a variation in a force of less than 5 gf precisely.

### BRIEF DESCRIPTION

Objectives, features, and advantages of the present invention are hereunder illustrated with specific embodiments in conjunction with the accompanying drawings, in which:

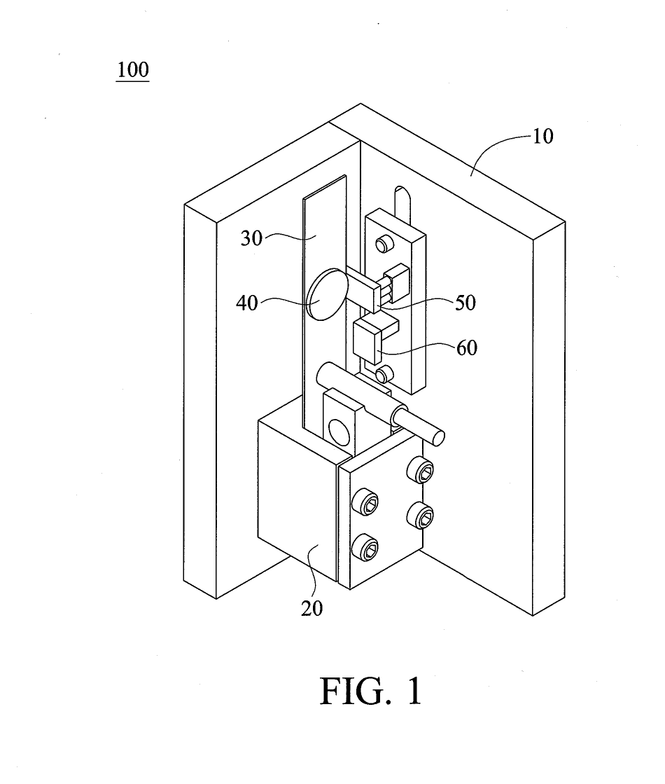

FIG. 1 is a perspective view of a microforce measuring device according to an embodiment of the present invention;

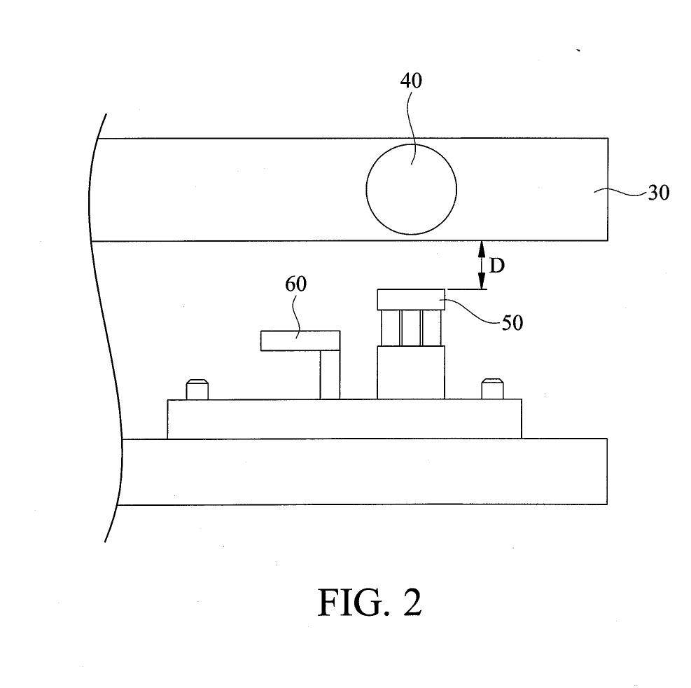

FIG. 2 is a schematic view of the distance between a magnetic component and a Hall effect sensing unit of the microforce measuring device according to the embodiment of the present invention;

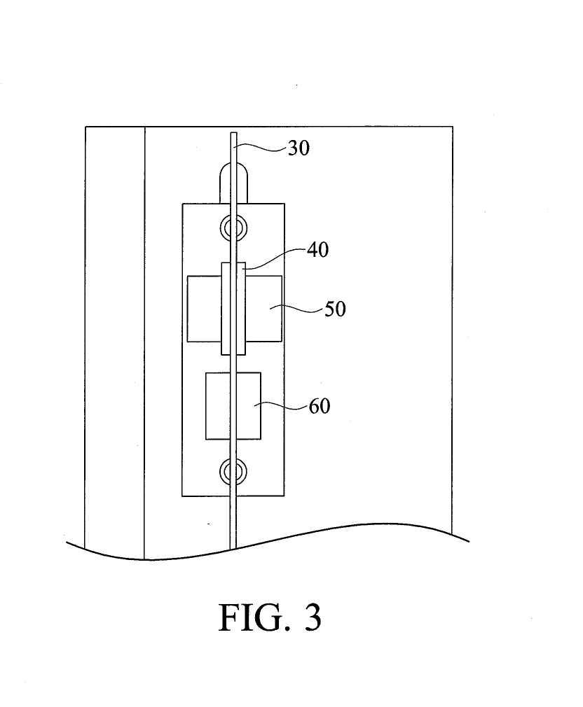

FIG. 3 is a schematic view of relative positions of the magnetic component and the Hall effect sensing unit of the microforce measuring device according to the embodiment of the present invention; and

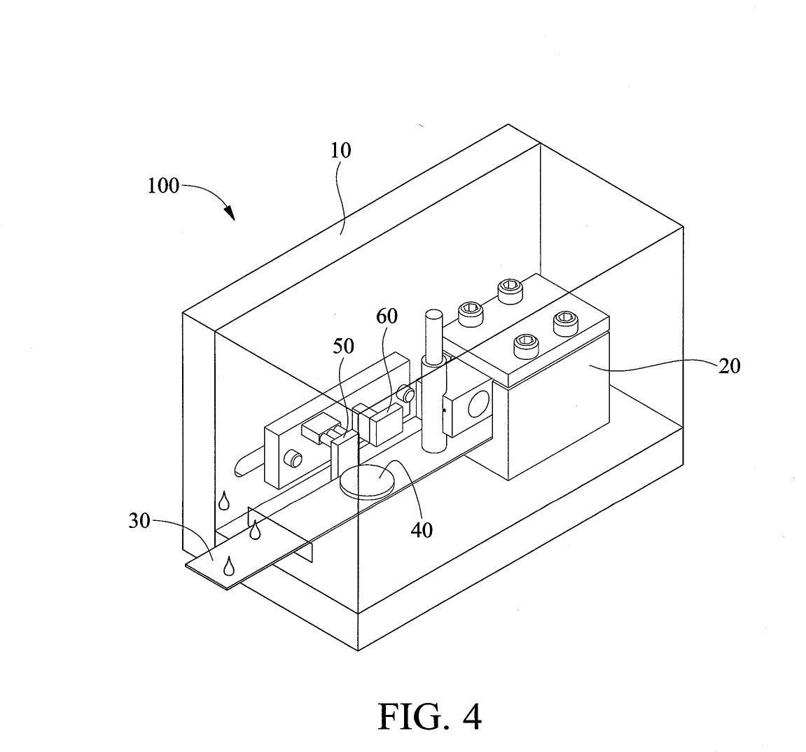

FIG. 4 is a schematic view of the microforce measuring device disposed outdoors according to the embodiment of the present invention.

### DETAILED DESCRIPTION

Referring to FIG. 1, a microforce measuring device 100 in an embodiment of the present invention measures the thrust of a ball screw (not shown). The microforce measuring device 100 comprises a base10, a fixing component 20, a cantilever 30, a magnetic component 40, a Hall effect sensing unit 50, and a signal processing unit 60.

The base10 is disposed in the vicinity of the ball screw. The fixing component 20 is disposed at the base10. The cantilever 30 is fixed at one end by the fixing component 20. The magnetic component 40 is disposed at the cantilever 30. The magnetic component 40 is a rectangular transversely-magnetized two-pole magnetic block, a rectangular longitudinally-magnetized two-pole magnetic block, a round axially-magnetized two-pole magnetic block, or a round radially-magnetized two-pole magnetic block, and is preferably a round axially-magnetized two-pole magnetic block, as shown in FIG. 1.

The Hall effect sensing unit 50 comprises a Hall component, a voltage regulator circuit, an amplifier, and the like. The Hall effect sensing unit 50 is disposed at the base10, aimed at the magnetic component 40, and spaced apart from the magnetic component 40 by a distance D (shown in FIG. 2). The distance D is preferably 5 mm, but can be shorter or longer than 5 mm in a variant embodiment of the present invention. The signal processing unit 60 is electrically connected to the Hall effect sensing unit 50.

The description below explains how the microforce measuring device 100 measures a microforce.

First, when the cantilever 30 is subjected to a force and thereby deformed, the magnetic component 40 undergoes displacement and thereby produces a change in its magnetic field. Then, the Hall effect sensing unit 50 senses the change in the magnetic field of the magnetic component 40 and generates a sensing signal. Finally, the signal processing unit 60 receives and analyzes the sensing signal to assess the microforce which the cantilever 30 is subjected to.

Since the Hall effect sensing unit 50 is intended not to measure the strain of the cantilever 30 but to measure the change of the magnetic field of the magnetic component 40, a variation in a force of less than 5 gf can be measured precisely without any external amplifier. The parts and components of the Hall effect sensing unit 50 are cheap and therefore are effective in reducing the manufacturing costs of the microforce measuring device of the present invention.

Although not shown in the drawings, the Hall effect sensing unit 50 is preferably a linear Hall transducer for enhancing the sensing precision of the Hall effect sensing unit 50.

Although not shown in the drawings, the signal processing unit 60 is connected to a computer for storing and comparing the sensing signals received in multiple experiments, so that related parameters of the experiments can be conveniently changed.

Although not shown in the drawings, the cantilever 30 is made of a magnetically impermeable material to prevent interference in the sensing precision of the Hall effect sensing unit 50.

Referring to FIG. 3, the Hall effect sensing unit 50 is aimed at the junction of the two poles of the magnetic component 40 to accurately sense any change in the magnetic field of the magnetic component 40.

In conclusion, the microforce measuring device of the present invention comprises the aforesaid parts and components to thereby reduce manufacturing costs and measure a variation in a force of less than 5 gf precisely.

Referring to FIG. 4, when the microforce measuring device is disposed outdoors and provided with waterproof protection, raindrops fall on the free end of the cantilever 30, leading to the following series of events: the cantilever 30 deforms under a force; the magnetic component 40 undergoes displacement and thereby its magnetic field changes; the Hall effect sensing unit 50 senses the change in the magnetic field of the magnetic component 40 and generates a sensing signal; and the signal processing unit 60 receives and analyzes the sensing signal to assess the microforce which the cantilever 30 is subjected to. Therefore, the microforce measuring device of the present invention, which analyzes multiple microforces and thereby assesses rain intensity, is applicable to weather forecast and disaster alert.

Although not shown in the drawings, the microforce measuring device of the present invention is also for use in sensing wind intensity, for example, in a series of steps as follows: the free end of the cantilever 30 is subjected to a gust of wind; the cantilever 30 deforms under a force; the magnetic component 40 undergoes displacement and thereby causes a change to its magnetic field; the Hall effect sensing unit 50 senses the change in the magnetic field of the magnetic component 40 and generates a sensing signal; and the signal processing unit 60 receives and analyzes the sensing signal to assess the microforce which the cantilever 30 is subjected to. Therefore, the microforce measuring device of the present invention, which analyzes multiple microforces and thereby assesses wind intensity, is applicable to weather forecast and disaster alert.

In conclusion, the microforce measuring device of the present invention not only advantageously reduces manufacturing costs and measures a variation in a force of less than 5 gf precisely but applies to the technical field of detecting multiple microforce variations, such as rain intensity detection, wind intensity detection, and burglar detection.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A microforce measuring device, comprising:
a base;
a fixing component disposed at the base;
a cantilever fixed at one end by the fixing component;
a magnetic component disposed at the cantilever;
a Hall effect sensing unit disposed at the base, aimed at the magnetic component, and spaced apart from the magnetic component by a distance to sense a change in a magnetic field of the magnetic component and generate a sensing signal; and
a signal processing unit electrically connected to the Hall effect sensing unit to receive and analyze the sensing signal.

2. The microforce measuring device of claim 1, wherein the Hall effect sensing unit and the magnetic component are spaced apart by a distance of 5 mm.

3. The microforce measuring device of claim 2, wherein the Hall effect sensing unit is aimed at a junction of two poles of the magnetic component.

4. The microforce measuring device of claim 1, wherein the Hall effect sensing unit is aimed at a junction of two poles of the magnetic component.

5. The microforce measuring device of claim 1, wherein the magnetic component is an axially-magnetized two-pole magnetic block.

6. The microforce measuring device of claim 1, wherein the Hall effect sensing unit is a linear Hall transducer.

7. The microforce measuring device of claim 1, wherein the cantilever is made of a magnetically impermeable material.
